(19) United States
(12) Patent Application Publication
(10) Pub. No.: US 2026/0368146 A1
(43) Pub. Date: Nov. 19, 2026

(54) LIST UPDATE METHOD, APPARATUS, DEVICE, STORAGE MEDIUM, AND PROGRAM PRODUCT

(71) Applicant: Futu Network Technology (Shenzhen) Co., Ltd., Shenzhen (CN)

(72) Inventors: Hanyu WANG, Shenzhen (CN); Jinying LIANG, Shenzhen (CN); Chu KE, Shenzhen (CN)

(73) Assignee: Futu Network Technology (Shenzhen) Co., Ltd., Shenzhen (CN)

(21) Appl. No.: 19/421,073

(22) Filed: Dec. 16, 2025

Related U.S. Application Data
(63) Continuation of application No. PCT/CN2025/137535, filed on Nov. 25, 2025.

(30) Foreign Application Priority Data
May 16, 2025 (CN) 202510636254.0

(51) Int. Cl. G06F 16/21; G06F 16/28

(52) U.S. Cl. CPC G06F 16/219; G06F 16/285

(57) ABSTRACT

A list update method, apparatus, device, storage medium, and program product. The method includes: configuring timeliness tags for lists in a first database according to business scenarios and data volumes, and configuring different message consumption channels for lists with different timeliness tags; obtaining a change stream of a binary log from a second database, where the change stream is configured to associate multiple target lists in the first database; pushing the change stream of the binary log to a message queue; routing the change stream of the binary log in the message queue to different message consumption channels for data processing according to the timeliness tags corresponding to the target lists; and writing processed data into a corresponding target list in the first database.

### CROSS REFERENCE TO RELATED APPLICATIONS

The present application is a continuation of International (PCT) Patent Application No. PCT/CN2025/137535, filed on Nov. 25, 2025, which claims foreign priority to Chinese Patent Application No. 202510636254.0, filed on May 16, 2025, the contents of which are herein incorporated by reference in their entireties.

### TECHNICAL FIELD

The present disclosure relates to the field of computer technology, and in particular to a list update method, apparatus, device, storage medium, and program product.

### BACKGROUND ART

In business systems, data tables are indispensable as data sources in various business functions, and different data tables are interrelated. When processing data in a single data table, the interrelation between different data tables generates a large number of read and write operations, leading to fierce resource competition. High load results in low data processing efficiency.

### SUMMARY OF THE DISCLOSURE

The embodiments of the present disclosure provide a list update method, apparatus, device, storage medium, and program product.

On one aspect, the embodiments of the present disclosure provide a list update method, and the method includes: configuring timeliness tags for lists in a first database according to business scenarios and data volumes, and configuring different message consumption channels for lists with different timeliness tags; obtaining a change stream of a binary log from a second database, where the change stream is configured to associate multiple target lists in the first database; pushing the change stream of the binary log to a message queue; routing the change stream of the binary log in the message queue to different message consumption channels for data processing according to the timeliness tags corresponding to the target lists; and writing processed data into a corresponding target list in the first database.

On another aspect, the embodiments of the present disclosure provide a list update apparatus, and the apparatus includes: a configuration unit, configured to configure timeliness tags for lists in a first database according to business scenarios and data volumes, and configure different message consumption channels for lists with different timeliness tags; an acquisition unit, configured to obtain a change stream of a binary log from a second database, where the change stream is configured to associate multiple target lists in the first database; a pushing unit, configured to push the change stream of the binary log to a message queue; a processing unit, configured to route the change stream of the binary log in the message queue to the different message consumption channels for data processing according to the timeliness tags corresponding to the target lists; a writing unit, configured to write processed data into a corresponding target list in the first database.

On another aspect, the embodiments of the present disclosure provide a computer device, where the computer device includes a processor and a memory, a computer program is stored in the memory, and the processor is configured to execute the list update method according to the foregoing embodiment by invoking the computer program stored in the memory.

On another aspect, the embodiments of the present disclosure provide a non-transitory computer-readable storage medium, where the computer-readable storage medium stores a computer program, and the computer program is adapted to be loaded by a processor to execute the list update method according to the foregoing embodiment.

On another aspect, the embodiments of the present disclosure provide a computer program product, including computer instructions, where the computer instructions implement the list update method according to the foregoing embodiment when executed by a processor.

### BRIEF DESCRIPTION OF THE DRAWINGS

To more clearly illustrate the technical solutions in the embodiments of the present disclosure, the followings briefly introduces the drawings required for describing the embodiments. Obviously, the drawings in the following description are only some embodiments of the present disclosure. For those skilled in the art, other drawings can be obtained according to these drawings without creative work.

FIG. 1 is a schematic flowchart of a list update method provided by some embodiments of the present disclosure.

FIG. 2 is a schematic diagram of a first application scenario of the list update method provided by some embodiments of the present disclosure.

FIG. 3 is a schematic diagram of a second application scenario of the list update method provided by some embodiments of the present disclosure.

FIG. 4 is a schematic diagram of a third application scenario of the list update method provided by some embodiments of the present disclosure.

FIG. 5 is a schematic diagram of a fourth application scenario of the list update method provided by some embodiments of the present disclosure.

FIG. 6 is a schematic structural diagram of a list update apparatus provided by some embodiments of the present disclosure.

FIG. 7 is a schematic structural diagram of a computer device provided by some embodiments of the present disclosure.

### DETAILED DESCRIPTION

The following clearly and completely may describe the technical solutions in the embodiments of the present disclosure with reference to the drawings in the embodiments of the present disclosure. Obviously, the described embodiments are only some rather than all of the embodiments of the present disclosure. Based on the embodiments in the present disclosure, all other embodiments obtained by those skilled in the art without creative work shall fall within the protection scope of the present disclosure.

The embodiments of the present disclosure may provide a list update method, apparatus, device, storage medium, and program product. In some embodiments, the list update method of the embodiments of the present disclosure may be executed by a computer device, where the computer device may be a terminal, a server, or other devices. The terminal may be a smartphone, a tablet computer, a laptop computer, a desktop computer, a smart TV, a smart speaker, a wearable smart device, a smart vehicle-mounted terminal, or the like. The terminal may further include a client, which may be a financial client, a browser client, an instant messaging client, or the like. The server may be an independent physical server, a server cluster or a distributed system including multiple physical servers, or a cloud server that may provide basic cloud computing services such as cloud services, cloud databases, cloud computing, cloud functions, cloud storage, network services, cloud communication, middleware services, domain name services, security services, content delivery network services, and big data and artificial intelligence platforms, but is not limited thereto.

In business systems, data tables are indispensable as data sources in various business functions, and different data tables are interrelated. In a case where data in a single data table is processed, the interrelation between different data tables may generate a large number of read and write operations, leading to fierce resource competition. High load may result in low data processing efficiency.

Taking a customer relationship management (CRM) system as an example, data lists may include a customer list, a customer follower assignment list, and a customer order list. The customer list may be configured to record all customers and their basic information, such as customer names and customer asset data. The customer follower assignment list may be configured to record the business managers serving the customers. The customer order list may be configured to record the order data of the customers. The CRM system may implement a data list service for searching and data aggregation of all data tables, such as customer query, customer order flow retrieval, and status check of assigned customer managers.

In some embodiments, a backend service may write data lists corresponding to business functions into a relational (MySQL) database. The data list service may adopt a search engine (Elasticsearch) database, and synchronize business data in MySQL to the Elasticsearch database by subscribing to a binary log (binlog) change stream of MySQL. Considering that the writing speed of the Elasticsearch database may be relatively slow, the CRM system may first write the binlog change stream into a distributed message (Kafka) queue, and then asynchronously process the data by message consumers before writing it into the Elasticsearch database. However, due to the different data volumes of different data lists and the interrelation between different data lists (for example, a customer name can be simultaneously called by the customer list, the customer follower assignment list, and the customer order list), the customer list may only have thousands of data entries, while the customer order list may involve tens of millions of data entries. Data lists of different volumes may compete for computing resources and bandwidth resources. For example, MySQL in the backend service may bear high load due to frequent responses to binlog reading and business writing. The Elasticsearch database of the data list service may have high batch writing pressure, and the indexing speed cannot keep up, further accumulating unprocessed data, which ultimately may slow down the processing efficiency of the entire system and may even trigger a service avalanche.

The following may describe each part in detail. It should be noted that the description order of the following embodiments may not limit the priority of the embodiments.

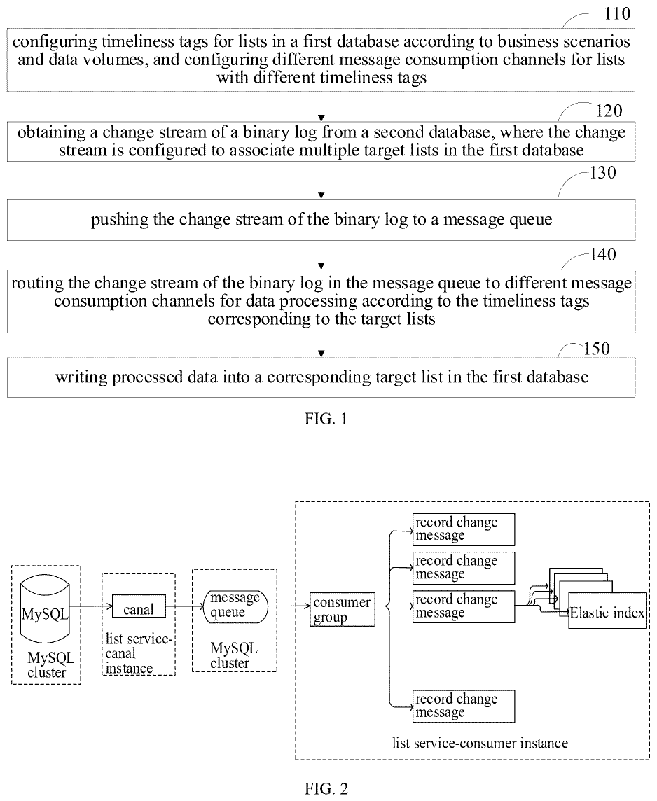

Referring to FIGS. 1 to 5, FIG. 1 is a schematic flowchart of a list update method provided by some embodiments of the present disclosure, and FIGS. 2 to 5 are schematic diagrams of application scenarios of the list update method provided by some embodiments of the present disclosure. The method may include the following operations.

Operation 110: configuring timeliness tags for lists in a first database according to business scenarios and data volumes, and configuring different message consumption channels for lists with different timeliness tags.

The business scenarios may be configured to indicate types of business function of business data stored in corresponding lists. It can be understood that different types of business functions may have different requirements for data update timeliness. The data volumes may be configured to indicate amounts of business data corresponding to the lists in the first database. It can be understood that updating business data of different data volumes may require different time and occupy different resources. The larger the data volume, the more time and resources may be required.

The timeliness tags may be configured to indicate processing timeliness required for data to be written into the lists. A message consumption channel may refer to a channel for processing the data to be written into the list, and may include at least one consumer group in some embodiments.

The lists in the first database may include different data lists under the business scenarios. For any list in the first database, the business scenario and data volume of the list may be obtained, and the timeliness tag required for the data to be written into the list and the message consumption channel corresponding to the timeliness tag may be determined based on the business scenario and data volume of the list.

In some embodiments, the higher the requirement for data update timeliness of the business function type indicated by the business scenario, the higher the level of the timeliness tag; conversely, the lower the level of the timeliness tag. The larger the amount of business data indicated by the data volume, the lower the level of the timeliness tag; conversely, the higher the level of the timeliness tag.

For example, taking the aforementioned CRM system as an example, in the data list service of the CRM system, first, the timeliness tags of the lists in the first database (such as Elasticsearch) may be classified according to the business scenarios and the urgency of data update. The first database may be a search engine (Elasticsearch) database.

For example, the customer list and the customer follower assignment list may correspond to business function types with high requirements for data update timeliness and small data volumes. That is, for the customer list or customer follower assignment list that may need to quickly reflect business data changes, they may be marked with a “high timeliness tag”, which may be usually expressed as “fast”. The customer order list may correspond to a business function type with low requirements for data update timeliness and a large data volume. That is, for the customer order list with low update frequency or low timeliness requirements, it may be marked with a “low timeliness tag”, which may be usually expressed as “slow”.

For different timeliness tags, independent message consumption channels can be configured for lists with different timeliness tags. Different message consumption channels may be configured with different resources to process binary logs related to data changes to be written into different lists at different speeds. In some embodiments, this can be implemented by creating different consumer groups through a Kafka message queue, where each consumer group may specifically process the binary logs with a specific timeliness tag.

For example, continuing with the aforementioned scenario, different Kafka consumer groups may be configured as message consumption channels for lists with different timeliness tags. Among them, lists with high timeliness tag (such as the customer list and the assignment list) may be processed by the fast message consumption channel, and lists with low timeliness tag (such as the flow list and the transaction order list) may be processed by the slow message consumption channel. This configuration may ensure that business data to be written into lists with different timeliness requirements can be efficiently processed through independent channels, reducing the possibility of tasks to be written into lists with low timeliness requirements blocking tasks to be written into lists with high timeliness requirements.

In some embodiments, configuring timeliness tags for lists in a first database according to business scenarios and data volumes, and configuring different message consumption channels for lists with different timeliness tags may include configuring timeliness tags for lists in the first database according to business scenarios and data volumes, and dividing the timeliness tags into a high timeliness tag and a low timeliness tag, where the high timeliness tag may correspond to a first message consumption channel, and the low timeliness tag may correspond to a second message consumption channel.

The timeliness tags may include the high timeliness tag and the low timeliness tag. The first message consumption channel corresponding to the high timeliness tag may be configured with higher resource parameters and concurrency parameters, and the second message consumption channel corresponding to the low timeliness tag may be configured with lower resource parameters and concurrency parameters.

For example, the timeliness of the lists in the first database may be distinguished according to business scenarios and data volumes. This may be to ensure that the lists with different business requirements and data importance may be provided with data processing and services matching their timeliness requirements.

In some embodiments, one timeliness tag may be configured for each list in the first database by the system and the timeliness tag may be determined according to factors such as the update frequency of business data in the list, business sensitivity, and data volume. In some embodiments of the present disclosure, the timeliness tags may include the high timeliness tag and the low timeliness tag. The high timeliness tag may be applicable to lists that may need to quickly reflect data changes and have high business sensitivity, such as the customer list and the customer follower assignment list. The business data changes of these lists may usually come from real-time business operations and require quick updates in the system. The low timeliness tag may be applicable to lists with infrequent data changes and low business sensitivity, such as the flow list and the customer order list. The data changes of these lists may come from regular pulling of data warehouses and have relatively low requirements for timeliness.

For example, to ensure that lists with different timeliness requirements can be processed in a timely and effective manner, different message consumption channels may be configured for lists with different timeliness tags by the system. For lists configured with the high timeliness tag, the system may associate them with the first message consumption channel, which may typically have higher priority and faster processing speed to ensure that data changes in high timeliness lists can be quickly captured, processed, and written into the second database.

For lists configured with the low timeliness tag, the system may associate them with the second message consumption channel, which may have relatively lower priority and processing speed since data changes in low timeliness lists may have less strict time requirements.

Through such configuration, the system can provide differentiated data processing services based on the timeliness requirements of different lists. This may not only improve the efficiency and accuracy of data processing but also ensure the timeliness and consistency of business operation data, thereby meeting diverse business needs and data volume requirements.

As shown in FIG. 2, the backend service can write its corresponding business data into its corresponding relational (MySQL) database. In the data list service, a canal instance may be configured for a MySQL database. The search engine (Elasticsearch) database can monitor data changes of MySQL through the canal instance to obtain the binary logs (binlogs) of the changed data. In some embodiments, after the backend service may receive a data change operation and write the changed data into its corresponding relational (MySQL) database, the Elasticsearch database may obtain a binary log (binlog) based on the change event through the canal instance. One binary log change event may be associated with multiple lists in the Elasticsearch database in the data list service, and each list may correspond to an index in the Elasticsearch database (i.e., the first database). After obtaining the binary log, the data list service may write it into the distributed message queue, and then the message consumer may asynchronously process the data before writing it into the corresponding index (index table) in the Elasticsearch database.

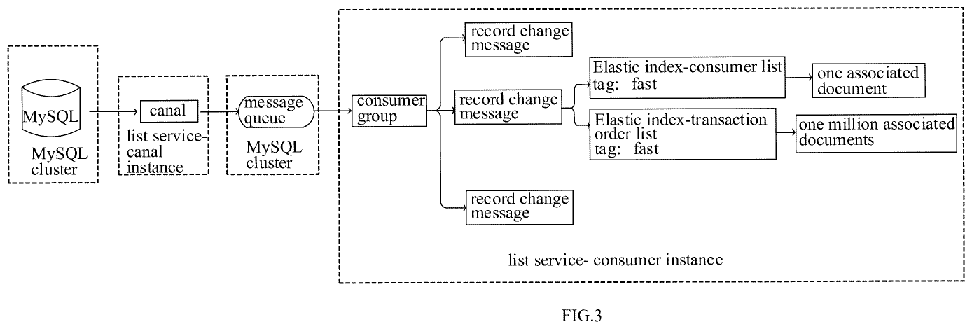

As shown in FIG. 3, taking customer information as an example, a customer name may be used by the customer list, the customer follower assignment list, the customer order list, etc. At the same time, each list may correspond to an index (index table) in the Elasticsearch database (i.e., the first database). Among them, in the customer order list, one customer may have 100,000 to 1,000,000 order records, while in the customer list, one customer may only involve 1 customer record. Therefore, in a case where the binary log related to the customer name may be processed, the binary log can be routed to different message consumption channels for the different index tables (i.e., multiple target lists in the first database), and processed by the message consumers in the different message consumption channels before being stored in the corresponding index tables.

Different lists may have different requirements for delay. For example, lists such as the customer list and the customer follower assignment list may have stronger requirements for the timeliness of responding to change events, and need to record the data changes corresponding to the change events in the lists as soon as possible for subsequent data query services. The customer order list may have weak requirements for the timeliness of responding to change events and low delay requirements, and the customer order list may often involve changes of multiple data and occupy more resources.

Lists under different data volumes and different business scenarios may need to be processed through different data paths. Therefore, in a case where the Es index tables (Elasticsearch index tables, i.e., each list in the first database) may be configured, different timeliness tags (tags) can be configured to mark, such as marking the “high timeliness tag” as “fast” and the “low timeliness tag” as “slow”. The configured timeliness tags may be read into a memory in a case where the list may be loaded, and can quickly determine the business timeliness required by the current target list to be processed during the subsequent data processing of the binary log and writing into the list.

The processing of lists with different timeliness tags (tags) should not use the same data path. As shown in FIG. 3, one binlog change stream of the customer name may be associated with the customer list and the customer order list. Usually, the customer list may be associated with 1 document, while the transaction order list may be associated with 1,000,000 documents. In response to the same data path being used, even with coroutine concurrency, the update of 1,000,000 documents may inevitably occupy a certain number of coroutine pools, which may cause the document associated with the customer list to not be updated in a timely manner, and at the same time block the binlog change streams of other unprocessed data, leading to a sharp increase in service load and database pressure, and affecting the delay of subsequent changes.

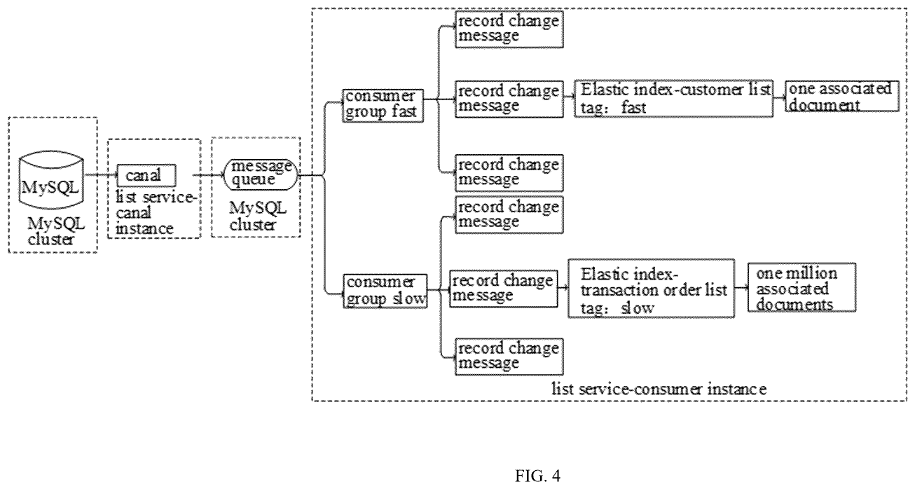

Therefore, as shown in FIG. 4, to separate the processing flows of lists with different timeliness tags (tags), in some embodiments of the present disclosure, different consumer channels may be configured for different timeliness tags, such as: a first message consumption channel corresponding to the “high timeliness tag”, which may include a high timeliness consumer group (consumer group fast), and a second message consumption channel corresponding to the “low timeliness tag”, which may include a low timeliness consumer group (consumer group slow). Continuing with the above example, different timeliness tags can be configured for the customer list and the transaction order list. The “high timeliness tag” may be configured for the customer list, and the “low timeliness tag” may be configured for the transaction order list. After one change stream of the binary log of a customer name may be obtained, on the one hand, based on the timeliness tag of the customer list, the binary log can be routed to the first message consumption channel (i.e., the high timeliness consumer group) corresponding to the “high timeliness tag”, and the binlog can be processed with data corresponding to the customer list through the first message consumption channel before being written into the customer list. On the other hand, based on the timeliness tag of the customer order list, the binary log can be routed to the second message consumption channel (i.e., the low timeliness consumer group) corresponding to the “low timeliness tag”, and the binary log can be processed with data corresponding to the customer order list before being written into the customer order list.

It can be understood that the high timeliness consumer group and the low timeliness consumer group may not increase additional storage costs. Different consumer groups may all consume the same message queue. For example, after the binary log may be written into the message queue, the high timeliness consumer group corresponding to the first message consumption channel may consume all the binary logs in the message queue. At the same time, the low timeliness consumer group corresponding to the second message consumption channel may consume all the binary logs in the message queue. For different consumer groups, each consumer group (such as the high timeliness consumer group and the low timeliness consumer group) may independently consume all the binary logs in the message queue. For different consumers in the same consumer group, one binary log in the message queue may be only consumed by one consumer, ensuring data consistency without additional storage costs and migration costs.

The transformation cost of setting different message consumption channels for different timeliness tags may be low. Taking the above setting of the first message consumption channel and the second message consumption channel as an example, the second message consumption channel may process the change stream of the binary log to be written into lists with the timeliness tag (tag) of slow, and the first message consumption channel may process the change stream of the binary log to be written into lists with the timeliness tag (tag) of fast. There may be only a distinction between timeliness tags (tags), and other operations such as reading of lists (tables), coroutine pool management, and Es writing process may be consistent with the original operations, resulting in little code intrusion. Distinguishing businesses through different message consumption channels (i.e., different consumer groups) can also achieve hardware isolation and strong scalability. Since lists with different timeliness tags (tags) may be already processed by different message consumption channels, in a case where the list level may grow again in the future, additional containers or machine instances can be configured to undertake the distributed (Kafka) message processing of large tables. The processor and memory can be configured independently, with strong scalability, which can cope with the regional expansion and growth of the business.

In some embodiments, configuring timeliness tags for lists in the first database according to business scenarios and data volumes, and dividing the timeliness tags into the high timeliness tag and the low timeliness tag may include: for each list in the first database, in a case where a business scenario of the list may be real-time feedback, or a number of documents in the list corresponding to a single change event may be less than a preset threshold, marking the list as the high timeliness tag. Alternatively, in a case where a business scenario of the list may be non-real-time feedback, or a number of documents in the list corresponding to a single change event may exceed a preset threshold, marking the list as the low timeliness tag.

For example, in a case where the business scenario of the list may be real-time feedback, that is, data changes may need to be quickly reflected in the business system, and the requirements for data update timeliness may be high, such as customer query and assignment status check, these scenarios may have extremely high requirements for data timeliness, so the list may be marked as the high timeliness tag.

For example, in a case where the number of documents in the list corresponding to a single change event may be less than a preset threshold (such as 10), it may mean that the data change frequency of the list may be relatively low, but each change may have an important impact on the business. Therefore, it may be also necessary to mark it as the high timeliness tag to ensure timely data update.

For example, in a case where the business scenario of the list may be non-real-time feedback, that is, data changes may not need to be reflected in the business system immediately, and the requirements for data update timeliness may be low, such as regular pulling of data warehouses and historical data analysis, these scenarios may have low requirements for data timeliness, so the list may be marked as the low timeliness tag.

For example, in a case where the number of documents in the list corresponding to a single change event may exceed a preset threshold (such as 10), it may mean that the data change frequency of the list may be relatively high, but each change may have a relatively small impact on the business. Therefore, it can be marked as the low timeliness tag to reduce the pressure of the system on data processing.

In some embodiments, configuring the different message consumption channels for the lists with the different timeliness tags may include: configuring a first message consumption channel for a list with the high timeliness tag; and configuring a second message consumption channel for a list with the low timeliness tag.

The first message consumption channel and the second message consumption channel may reuse a topic and a partition of a same message queue, and the first message consumption channel and the second message consumption channel may be isolated through a message consumption channel identifier.

For example, different message consumption channels may be configured for lists with different timeliness tags by the system to ensure that data can be processed according to their timeliness requirements. In some embodiments, the configuration method may be as follows.

The first message consumption channel may be configured for a list with the high timeliness tag. This channel may have higher priority and faster processing speed to ensure that data changes of the high timeliness list can be quickly captured, processed, and written into the second database.

The second message consumption channel may be configured for a list with the low timeliness tag. This channel may have relatively low priority and processing speed because the data changes of the low timeliness list may have less strict time requirements.

It is worth noting that to reduce system complexity and storage costs, the first message consumption channel and the second message consumption channel may reuse the topic and partition of the same message queue. However, the system may isolate these two channels through message consumption channel identifiers to ensure that they can independently process their respective message streams without interfering with each other.

In some embodiments, the timeliness tags of different lists can be adaptively and real-time adjusted according to the change fields corresponding to the currently occurring change events, so as to flexibly process the updated data and improve data processing efficiency. In some embodiments, configuring timeliness tags for the lists in the first database according to the business scenarios and the data volumes may include: responding to a change event, the change fields of the change event may be obtained; a first processing priority factor of the lists may be determined based on the business scenario of the lists in the first database; at the same time, the field data volumes under different fields in the lists may be obtained, and a second processing priority factor of the lists may be determined according to the field data volumes of the change fields and the field data volumes of other fields except the change fields; the timeliness tag of the lists may be determined according to the first processing priority factor and the second processing priority factor.

The first processing priority factor may be configured to indicate the requirement for data update timeliness of the business function of the business data stored in the corresponding list. For example, the larger the first processing priority factor, the higher the requirement for data update timeliness of the business function of the business data stored in the corresponding list. In some embodiments, different processing priority factors can be preset for different business scenarios. After the business scenarios of the list may be obtained, the corresponding first processing priority factor may be obtained based on the mapping relationship between different business scenarios and different processing priority factors.

For example, 4 business scenarios may be involved. The corresponding processing priority factor under business scenario A may be 0.25, under business scenario B may be 0.5, under business scenario C may be 0.75, and under business scenario D may be 1.

The second processing priority factor may be configured to indicate the impact of the data volume of the business data in the corresponding list on the data update timeliness. For example, the smaller the second processing priority factor, the greater the impact of the data volume of the business data in the corresponding list on the data update timeliness. The field data volume may refer to the number of values under a certain field. In some embodiments, after obtaining the number of values of different fields in the list, the second processing priority factor of the list can be determined by the following formula:

$${Q}_{2} = \frac{1}{n - 1} {\sum }_{i = 1}^{n - 1} \frac{{num}_{b inlog}}{{field}_{i}}$$

Q₂ may represent the second processing priority factor, num_{binlog} may represent the field data volume of the change field, field; may represent the field data volume of the i-th field except the change field, and n may represent the number of fields in the list. It can be understood that for the change field, the maximum value of the ratio of the field data volume of the change field to the field data volume of other fields may be 1, which may mean that one value of the change field can retrieve 1 record corresponding to other fields in the list. The ratio of the field data volume of the change field to the field data volume of other fields may be less than 1, which may mean that one value of the change field can retrieve multiple records corresponding to other fields in the list. The smaller the ratio, the more records corresponding to other fields can be retrieved by one value of the change field in the list. At this time, the data volume of the business data that may need to be updated by the change event in the corresponding list may be larger, requiring more time and resource occupation, and having a greater impact on the data update timeliness.

In some embodiments, timeliness tags corresponding to different processing priority factors can be preset. For example, a target processing priority factor greater than 0.5 can be determined as the high timeliness tag, and the target processing priority factor less than or equal to 0.5 can be determined as the low timeliness tag.

After determining the first processing priority factor and the second processing priority factor, the weighted average of the first processing priority factor and the second processing priority factor can be calculated to obtain the target timeliness tag of the list, and then the corresponding timeliness tag can be determined based on the target processing priority factor. The weight corresponding to the first processing priority factor and the second processing priority factor can be set according to empirical values.

In some embodiments, the method may further include: configuring different concurrency parameters for different message consumption channels, where the concurrency parameters may include at least one of a size of a coroutine pool, a query concurrency of the second database, and a write concurrency of the first database.

To further optimize the data processing flow and ensure the stability and performance of the system in a high-concurrency environment, the method may further include configuring the different concurrency parameters for the different message consumption channels. These concurrency parameters may include at least one of the size of the coroutine pool, the query concurrency of the second database (such as MySQL), and the write concurrency of the first database (such as Elasticsearch).

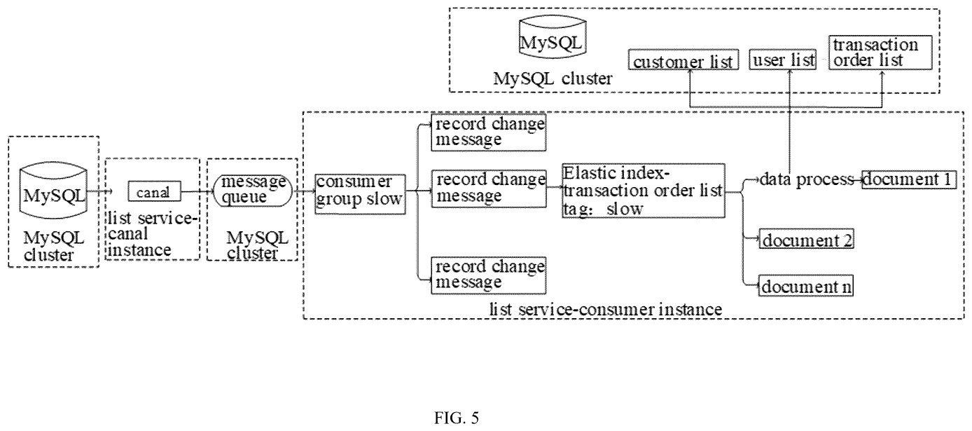

As shown in FIG. 5, the process from the binlog change stream to the processed Es document may need to go through multiple complex processes, and due to the large data volume, these processes may usually use coroutine pools for concurrent processing. However, although the increase in concurrency can reduce delay and improve processing speed, it may require more coroutines. For example, an Es document of the transaction order list may need to obtain original data by querying multiple MySQL tables before processing. Therefore, the greater the concurrency, the greater the query pressure on the MySQL cluster. At the same time, the Es cluster may also have a write limit. In a case where the write concurrency may be too large, the read delay of the Es cluster will also become longer, further increasing the fuzzy search query delay of the list. Therefore, to balance the delay and the read-write pressure of the database cluster, it may be necessary to configure reasonable concurrency parameters for different message consumption channels (i.e., lists with different timeliness tags).

For the configuration method of the size of the coroutine pool: for the list with the high timeliness tag, since its data changes may need to be processed quickly, a larger coroutine pool size can be configured for it to ensure sufficient concurrent processing capabilities to quickly respond to data changes. For the list with the low timeliness tag, since its data changes may have less strict time requirement, the size of the coroutine pool can be appropriately reduced to reduce system resource consumption and concurrency pressure.

For the configuration method of the query concurrency of the second database (such as MySQL): considering the query pressure of the MySQL cluster, for the list with the high timeliness tag, the query concurrency can be moderately controlled to reduce the possibility of performance degradation of the MySQL cluster due to excessive concurrency. For the list with the low timeliness tag, since its requirement for delay may be relatively low, the query concurrency can be further reduced to reduce the burden on the MySQL cluster.

For the configuration method of the write concurrency of the first database (Elasticsearch): the Elasticsearch cluster may have the write limit. In a case where the write concurrency may be too large, it will lead to longer read delays and affect the fuzzy search query performance of the list. Therefore, for the list with the high timeliness tag, it may be necessary to reasonably configure the write concurrency to ensure that the rapid writing may not excessively affect the performance of the Elasticsearch cluster. For the list with the low timeliness tag, since its write pressure may be relatively small, the write concurrency can be appropriately reduced to optimize the overall system performance.

For example, the concurrency parameters may be configured according to the method of distinguishing timeliness tags (tags) by association ratio.

For example, in a case where the number of documents in a single Es index table corresponding to one binlog change event may exceed the preset threshold (such as 10), the list may be marked as the low timeliness tag and its concurrency parameters may be accordingly reduced.

For example, for the low timeliness list marked with the low timeliness tag (slow), the configuration strategy for its processing concurrency should focus on system stability rather than excessive pursuit of low delay. In some embodiments, compared with the high timeliness consumer group that may process high timeliness lists, the number of binlog coroutines in the low timeliness consumer group that may process low timeliness lists may be reduced to 5 or less. This may be to reduce the occupation of system resources during concurrent processing and reduce the possibility of system instability caused by excessive concurrency. In the low timeliness consumer group, the concurrent processing number at the list level may be set to 2 or lower. This setting may help to further reduce the system load and ensure the stable operation of the system in response to the low timeliness list being processed. For each document in the low timeliness consumer group, the concurrency number of its processing queries and writes may also be limited to 5 or less. This measure may aim to reduce the pressure on the database and storage system and prevent performance degradation or system crash caused by excessive concurrency.

At the same time, parameters may need to be tuned according to the hardware configuration of different clusters. By detecting and analyzing system performance data, the values of concurrency parameters may be continuously adjusted to find an optimal balance between the update speed of the list and the load saturation of the cluster.

In some embodiments, configuring the different concurrency parameters for the different message consumption channels may include: the size of the coroutine pool corresponding to the first message consumption channel being larger than the size of the coroutine pool corresponding to the second message consumption channel; the query concurrency of the second database corresponding to the first message consumption channel being higher than the query concurrency of the second database corresponding to the second message consumption channel; and the write concurrency of the first database corresponding to the first message consumption channel being higher than the write concurrency of the first database corresponding to the second message consumption channel.

For example, regarding the size of the coroutine pool, the size of the coroutine pool corresponding to the first message consumption channel may be configured to be larger than that corresponding to the second message consumption channel. This may be because the first message consumption channel may process lists with the high timeliness tag, and the data changes of these lists may need to be quickly responded to and processed. Therefore, more coroutines may be needed to execute tasks concurrently to reduce delay and improve processing speed. On the contrary, the second message consumption channel may process lists with low timeliness tag, and the data changes of these lists may have less strict time requirements. Therefore, the size of the coroutine pool can be reduced to reduce system resource consumption and concurrency pressure.

For example, regarding the query concurrency of the second database, the query concurrency of the second database corresponding to the first message consumption channel may be also set to be higher than that of the second message consumption channel. This may be because the data processing of the high timeliness lists may often need to query multiple MySQL tables to obtain original data and perform complex calculations and processing. To improve processing efficiency, it may be necessary to increase the query concurrency to obtain the required data in parallel. For low timeliness lists, since their data changes may be not frequent and have low time requirements, the query concurrency can be reduced to reduce the burden on the MySQL cluster and the possibility of performance degradation caused by excessive concurrency.

For the write concurrency of the first database, the write concurrency of the first database corresponding to the first message consumption channel may be also configured to be higher than that of the second message consumption channel. This may be because the data changes of high timeliness lists may need to be quickly reflected in storage systems such as Elasticsearch for subsequent query and analysis. Therefore, it may be necessary to increase the write concurrency to quickly write the processed data into the first database. For low timeliness lists, since their data changes may have less strict time requirements, the write concurrency can be reduced to optimize the performance of the Elasticsearch cluster and reduce the possibility of longer read delays or system crashes caused by too many write operations.

By configuring different concurrency parameters for different message consumption channels, the delay, the read-write pressure of the database cluster, and the system performance can be more effectively balanced, ensuring the efficient and stable operation of the data processing flow, and meeting different business needs and data volume requirements.

In some embodiments, the method may further include: dynamically adjusting the concurrency parameters of the first message consumption channel and the second message consumption channel according to preset monitoring indicators, where the preset monitoring indicators may include at least one of the followings: a container resource utilization rate, a query response time and an active connection count of the second database, a write throughput of the first database, an update speed of each list in the first database, and a message backlog of different timeliness tags in the message queue.

In some embodiments, dynamically adjusting the concurrency parameters of the first message consumption channel and the second message consumption channel according to preset monitoring indicators may include:

In response to the container resource utilization rate exceeding a first preset utilization rate threshold (such as 80%), the first message consumption channel may be decreased by a first percentage (such as 10%) of the current coroutine pool size until the container resource utilization rate may drop below a second preset utilization rate threshold (such as 75%); and/or the second message consumption channel may be decreased by a second percentage (such as 15%) of the current coroutine pool size until the container resource utilization rate may drop below the second preset utilization rate threshold (such as 75%); the first preset utilization rate threshold may be greater than the second preset utilization rate threshold, and the first percentage may be less than the second percentage.

In response to the container memory utilization rate exceeding a third preset utilization rate threshold (such as 85%), the coroutines processing low-priority messages (such as non-real-time feedback type, log type) in the first message consumption channel may be forcibly terminated. For the second message consumption channel, the memory swap compression mechanism may be enabled and the memory reservation ratio of batch processing tasks may be reduced. The third preset utilization rate threshold may be greater than the first preset utilization rate threshold.

In some embodiments, dynamically adjusting the concurrency parameters of the first message consumption channel and the second message consumption channel according to preset monitoring indicators may include:

In response to the query response time of the second database exceeding a preset response time threshold (such as 500 ms), for the first message consumption channel, the query concurrency of the second database corresponding to the first message consumption channel may be reduced to a third percentage (such as 50%) of the current query concurrency; and/or for the second message consumption channel, the query result caching mechanism may be enabled and the cache expiration time may be extended.

In response to the active connection count of the second database exceeding a fourth percentage (such as 80%) of the maximum connection count of the second database, for the first message consumption channel, connections that may have been idle for more than a first preset time (such as 30 seconds) may be forcibly released to the connection pool; and/or for the second message consumption channel, a connection reuse technology may be adopted and one single query may be split into multi-stage execution.

In some embodiments, dynamically adjusting the concurrency parameters of the first message consumption channel and the second message consumption channel according to preset monitoring indicators may include:

In response to the write throughput of the first database being lower than a fifth percentage (such as 70%) of the target throughput value for n consecutive monitoring cycles (such as 3), for the first message consumption channel, the asynchronous write merging mechanism may be enable to merge small-batch writes into large batches greater than or equal to 1 MB; and/or for the second message consumption channel, the write concurrency of the first database corresponding to the second message consumption channel may be reduced to a sixth percentage (such as 30%) of the current write concurrency, and the write buffer queue may be enabled.

In some embodiments, dynamically adjusting the concurrency parameters of the first message consumption channel and the second message consumption channel according to preset monitoring indicators may include:

In response to the update speed of the list being lower than a preset update speed threshold (such as 2s), for the first message consumption channel, the real-time update of the list may be suspended and the first message consumption channel may be switched to an asynchronous compensation mode; and/or for the second message consumption channel, the index precomputation service may be enabled to generate index fragments for high-frequency queries in advance.

In some embodiments, dynamically adjusting the concurrency parameters of the first message consumption channel and the second message consumption channel according to preset monitoring indicators may include:

In response to the message backlog of the high timeliness tag exceeding a seventh percentage (such as 20%) of the partition capacity, for the first message consumption channel, the first message consumption channel may be expanded to 1.5 times the current channel size and multi-threaded parallel consumption may be enabled; and an alarm message may be automatically triggered, and a standby message consumption channel may be started in a case where it may be not alleviated within a second preset time (such as 10 minutes).

In response to the message backlog of the low timeliness tag exceeding an eighth percentage (such as 50%) of the partition capacity, for the second message consumption channel, the message compression and dump mechanism may be enabled to migrate historical messages to cold storage; the message retention policy may be dynamically adjusted and messages that may exceed a preset number of days (such as 7 days) may be forcibly cleaned up; the eighth percentage may be greater than the seventh percentage.

In some embodiments, the method may further include: in response to multiple monitoring indicators triggering the adjustment strategy of concurrency parameters at the same time, execute them according to the following priority.

First priority: container resource critical alarm>database connection pool exhaustion>message queue high backlog.

Second priority: database query timeout>index write delay>batch write failure.

A smooth transition may be implemented during the adjustment process, with each parameter change interval not less than 30 seconds to reduce the possibility of system shock.

Operation 120: obtaining a change stream of a binary log from a second database, where the change stream may be configured to associate multiple target lists in the first database.

In some embodiments, the second database may be a relational database. Obtaining the change stream of a binary log from the second database may include: obtaining the change stream of the binary log from the relational database through a change data capture (CDC) subscription module.

For example, a CDC tool may be configured to subscribe to the binary log (binlog) change stream of the relational (MySQL) database (i.e., the second database). The CDC tool can real-time capture database change events, including insert, update, and delete operations. Then, the captured binlog change events may be converted into a structured binlog change stream for subsequent processing. Then, by parsing the binlog change events, the target lists in the first database associated with the binlog change events may be determined. For example, a change of a customer record may be associated with the customer list, the account list, and the transaction order list. Subsequently, according to the parsing result, the change events may be distributed to the processing flows of the corresponding target lists.

As shown in FIG. 4, the CDC tool can be implemented by a canal instance. Canal may be an open-source framework based on the incremental log parsing of MySQL databases, providing incremental data subscription and consumption. And the canal may be mainly configured for real-time data synchronization from MySQL databases to other data storage or systems. In some embodiments of the present disclosure, the canal instance may be an instance running the canal service, which may be responsible for connecting to the MySQL database, capturing and parsing the incremental logs (such as binlog change streams) of the MySQL database, and then sending these change streams to a specified message queue (such as Kafka) in the form of messages.

The binary log (binlog) may be a log format used by MySQL databases to record data changes. It may detail every data modification operation that may occur in the database. In response to the data in the database changing, such as inserting, updating, or deleting records, MySQL may write these changes into the binlog log file in binary form. Therefore, the binlog change stream may be actually a real-time stream of these database modification operations.

For example, the binlog change stream may usually include event type, change data, change time, table information, and other metadata.

For example, the event type may be configured to indicate the type of change that occurred, such as insert (INSERT), update (UPDATE), delete (DELETE), etc. The event type may be configured to identify and process different data changes.

For example, for the change data of insert operations and update operations, it may include specific change data, that is, the content of the newly inserted or updated records. For the change data of delete operations, it can include the unique identifier (such as primary key) of the deleted records.

For example, the change time may be configured to record timestamps in response to the data changes occurring, which may help determine the order and time point of the change during data synchronization or recovery.

For example, the table information may be configured to indicate which table the change occurred on, including the table name, database name, etc., which may be necessary for locating and processing data changes.

For example, other metadata may be some additional metadata, such as transaction ID (Identification), user information, etc., which may be configured to data recovery or auditing in certain scenarios.

Operation 130: pushing the change stream of the binary log to a message queue.

For example, after capturing and parsing the binary log change stream of the MySQL database, push the change messages in the change stream to the message queue (such as a Kafka queue) through the canal instance in the list service shown in FIG. 4. As an intermediate buffer layer, the message queue can store and forward a large number of change messages, ensuring the reliability and efficiency of data processing.

Operation 140: routing the change stream of the binary log in the message queue to different message consumption channels for data processing according to the timeliness tags corresponding to the target lists.

As shown in FIG. 4, in the message queue (such as the Kafka queue), according to the timeliness tag (fast or slow) of the target list in the change message of the change stream, the change message of the change stream may be routed to the corresponding message consumption channel, and then the binary log of the change stream may be processed through the consumer group (high timeliness consumer group or low timeliness consumer group) in the message consumption channel. This may be implemented through the routing mechanism of Kafka, ensuring that data with different timeliness requirements can be correctly distributed to their respective message consumption channels for processing.

In the message consumption channel, the change messages received may be processed by any consumer in the consumer group of the message consumption channel. This may include querying other associated tables in the MySQL database, calculating combined data, converting data formats, and other operations to generate data that may meet the requirements of the Elasticsearch list.

Operation 150: writing processed data into a corresponding target list in the first database.

For example, after data processing, the generated data may be written into the corresponding Elasticsearch list through the client or Application Programming Interface (API) of Elasticsearch. In this way, Elasticsearch can perform query and aggregation operations based on the latest data to meet business needs.

In response to the data being written, it may be also necessary to consider factors such as the write limit and read delay of the Elasticsearch cluster. By optimizing measures such as adjusting concurrency parameters and hardware configuration, the efficiency and stability of data writing can be ensured, while reducing the possibility of excessive pressure on the Elasticsearch cluster.

In some embodiments, before writing the processed data into the corresponding target list in the first database, the method may further include: performing verification and deduplication processing on the processed data; and according to results of the verification and deduplication processing, performing formatting processing on the processed data that may meet requirements to conform to a storage format of the corresponding target list in the first database.

For example, the processed data can be checked item by item through preset verification rules or algorithms. For example, check whether data fields may be missing, whether data types may be correct, whether data values may be within a reasonable range, etc. In a case where the data may not meet the verification rules, corresponding error handling or data correction may be performed.

For example, duplicate records can be identified and removed by comparing key fields of data records (such as unique identification ID, business primary key, etc.). Common deduplication methods may include hash deduplication, sort deduplication, and set-based deduplication, etc.

For example, according to the storage format requirements of the target list, the processed data can be converted and formatted accordingly. For example, the data field name may be converted to the corresponding field name in the target list, the data type may be converted to the data type supported by the target list, the data may be formatted into the format required by the target list, etc.

Through the above verification, deduplication, and formatting operations, it can be ensured that the processed data may have undergone strict quality control and format conversion before being written into the corresponding target list in the first database, thereby ensuring the quality and consistency of the data, helping to improve the reliability, accuracy, and availability of the data, and providing strong support for subsequent data query, analysis, and application.

The embodiments of the present disclosure can mark timeliness tags (tags) according to the business delay sensitivity of different lists to distinguish processing. In the CRM system, different data lists may have different requirements for delay. For example, changes to the customer list and the assignment list may usually come from business operations on the browser side, so the timeliness requirements may be stronger, and they may need to be reflected in the lists as soon as possible. Changes to the flow list and the transaction order list may come from the pulling of data warehouses, and the timeliness requirement may be relatively low. To meet this differentiated demand, in this embodiment, different timeliness tags may be configured for different lists, such as “fast” and “slow”, so that they can be treated differently in the subsequent data processing process, ensuring that the data of the high timeliness list can be updated quickly, while the data of the low timeliness list can be updated on the premise of ensuring stability.

The embodiments of the present disclosure can undertake the traffic of lists with different timeliness tags (tags) by establishing new consumer groups (consumer groups), with no additional storage costs and low code transformation costs. In the traditional data synchronization scheme, a single consumer group may be usually configured to process all data changes, which may lead to competition for resources between list data of different volumes and different delay requirements in the same channel, affecting the performance and stability of the system. To solve this problem, this embodiment may establish multiple consumer groups, such as “high timeliness consumer group” and “low timeliness consumer group”, to undertake the traffic of lists with the high timeliness tag and the low timeliness tag respectively. The advantage of this may be that list data with different timeliness tags can be processed in their respective consumer groups, reducing the possibility of resource competition and improving the concurrent processing capability of the system. At the same time, since these consumer groups may all consume the same queue and partition, no additional storage costs may be added, and the code transformation cost may be relatively low.

The embodiments of the present disclosure may propose concurrency parameter tuning for different timeliness tags (tags), taking into account the impact of containers, MySQL clusters, Es clusters, list update speed, and other aspects. In the data processing process, the setting of concurrency parameters may have a crucial impact on system performance. Excessively high concurrency may increase the pressure on the database and storage system, while excessively low concurrency may increase the data update delay. To balance the needs of these two aspects, the embodiments of the present disclosure may perform refined tuning of concurrency parameters according to different timeliness tags and specific business scenarios. For example, for the list with the high timeliness tag, the concurrency parameters can be appropriately increased to improve the data update speed; for the list with the low timeliness tag, the concurrency parameters can be appropriately reduced to reduce the pressure on the database and storage system. In this way, while ensuring the data update speed, the stability and sustainability of the system may be also ensured.

All the above technical solutions can be combined arbitrarily to form embodiments of the present disclosure, which will not be repeated here.

In some embodiments of the present disclosure, configure timeliness tags for lists in the first database according to business scenarios and data volumes, and configure different message consumption channels for lists with different timeliness tags; obtain the change stream of the binary log from the second database, where the change stream may be configured to associate multiple target lists in the first database; push the change stream of the binary log to the message queue; route the change stream of the binary log in the message queue to different message consumption channels for data processing according to the timeliness tags corresponding to the target lists; and write the processed data into the corresponding target list in the first database. By configuring timeliness tags for lists in the first database according to business scenarios and data volumes and configuring different message consumption channels for lists with different timeliness tags, the embodiments of the present disclosure can realize refined management and optimized processing of data. By obtaining the change stream of the binary log from the second database, pushing it to the message queue, and then routing the change stream to different message consumption channels for data processing according to the timeliness tags, the possibility of competition for computing resources and bandwidth resources between data of different volumes may be effectively reduced, the load between the first database and the second database may be balanced, and the processing efficiency and resource utilization of list updates in the databases may be improved.

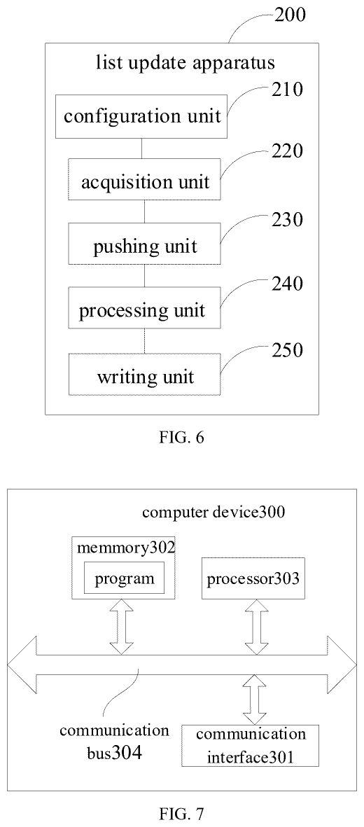

To facilitate the better implementation of the list update method of the embodiments of the present disclosure, the embodiments of the present disclosure may also provide a list update apparatus. Referring to FIG. 6, FIG. 6 is a schematic structural diagram of a list update apparatus provided by some embodiments of the present disclosure. The list update apparatus 200 may include the followings.

A configuration unit 210 may be configured to configure timeliness tags for lists in a first database according to business scenarios and data volumes, and configure different message consumption channels for lists with different timeliness tags.

An acquisition unit 220 may be configured to obtain a change stream of a binary log from a second database, where the change stream may be configured to associate multiple target lists in the first database.

A pushing unit 230 may be configured to push the change stream of the binary log to a message queue.

A processing unit 240 may be configured to route the change stream of the binary log in the message queue to the different message consumption channels for data processing according to the timeliness tags corresponding to the target lists.

A writing unit 250 may be configured to write processed data into a corresponding target list in the first database.

In some embodiments, the configuration unit 210 may be configured to configure the timeliness tags for the lists in the first database according to the business scenarios and the data volumes, and dividing the timeliness tags into a high timeliness tag and a low timeliness tag, and configure different message consumption channels for lists with different timeliness tags, where the high timeliness tag may correspond to a first message consumption channel, and the low timeliness tag may correspond to a second message consumption channel.

In some embodiments, the configuration unit 210 may be configured to configure the timeliness tags for the lists in the first database according to the business scenarios and the data volumes, and dividing the timeliness tags into the high timeliness tag and the low timeliness tag, where the configuration unit may be further configured to: for each list in the first database, in a case where a business scenario of the list may be real-time feedback, or a number of documents in the list corresponding to a single change event may be less than a preset threshold, mark the list with the high timeliness tag; or in a case where the business scenario of the list may be non-real-time feedback, or a number of documents in the list corresponding to a single change event may exceed a preset threshold, mark the list with the low timeliness tag.

In some embodiments, the configuration unit 210 may be configured to configure different message consumption channels for lists with different timeliness tags, including: configuring a first message consumption channel for the list with the high timeliness tag; configuring a second message consumption channel for the list with the low timeliness tag; the first message consumption channel and the second message consumption channel may reuse a topic and a partition of a same message queue, and the first message consumption channel and the second message consumption channel may be isolated through a message consumption channel identifier.

In some embodiments, the configuration unit 210 may be further configured to configure different concurrency parameters for different message consumption channels, where the concurrency parameters may include at least one of a size of a coroutine pool, a query concurrency of the second database, and a write concurrency of the first database.

In some embodiments, the configuration unit 210 may be configured to configure different concurrency parameters for different message consumption channels, where the size of the coroutine pool corresponding to the first message consumption channel may be larger than the size of the coroutine pool corresponding to the second message consumption channel; the query concurrency of the second database corresponding to the first message consumption channel may be higher than the query concurrency of the second database corresponding to the second message consumption channel; and the write concurrency of the first database corresponding to the first message consumption channel may be higher than the write concurrency of the first database corresponding to the second message consumption channel.

In some embodiments, the configuration unit 210 may be further configured to dynamically adjust the concurrency parameters of the first message consumption channel and the second message consumption channel according to preset monitoring indicators, where the preset monitoring indicators may include at least one of the followings: a container resource utilization rate, a query response time and an active connection count of the second database, a write throughput of the first database, an update speed of each list in the first database, and a message backlog of the different timeliness tags in the message queue.

In some embodiments, before the writing unit 250 may be configured to write the processed data into the corresponding target list in the first database, the writing unit 250 may perform verification and deduplication processing on the processed data, and according to results of the verification and deduplication processing, the writing unit 250 may perform formatting processing on the processed data that may meet the requirements to conform to a storage format of the corresponding target list in the first database.

All the above technical solutions can be combined arbitrarily to form embodiments of the present disclosure, which will not be repeated here.

It should be understood that the apparatus embodiments may correspond to the method embodiments, and similar descriptions can refer to the method embodiments. To avoid repetition, details may be not repeated here. In some embodiments, the list update apparatus can execute the above list update method embodiments, and the foregoing and other operations and/or functions of each unit in the list update apparatus may respectively implement the corresponding processes of the above method embodiments, which may be not repeated here for brevity.

In some embodiments, the present disclosure may further provide a computer device, including a memory and a processor, where the memory may store a computer program, and the processor may execute the operations in the above method embodiments in response to executing the computer program.

FIG. 7 is a schematic structural diagram of a computer device provided by some embodiments of the present disclosure, which may be a terminal or a server. As shown in FIG. 7, the computer device 300 may include: a communication interface 301, a memory 302, a processor 303, and a communication bus 304. The communication interface 301, the memory 302, and the processor 303 may implement mutual communication through the communication bus 304. The communication interface 301 may be configured to data communication between the computer device 300 and external devices. The memory 302 may be configured to store software programs and modules. The processor 303 may run the software programs and modules stored in the memory 302, such as the software programs for the corresponding operations in the foregoing method embodiments.

In some embodiments, the processor 303 may invoke the software programs and modules stored in the memory 302 to execute the following operations: configuring timeliness tags for lists in a first database according to business scenarios and data volumes, and configuring different message consumption channels for lists with different timeliness tags; obtaining a change stream of a binary log from a second database, where the change stream may be configured to associate multiple target lists in the first database; pushing the change stream of the binary log to a message queue; routing the change stream of the binary log in the message queue to different message consumption channels for data processing according to the timeliness tags corresponding to the target lists; writing processed data into a corresponding target list in the first database.

A person of ordinary skill in the art can understand that all or part of the operations in the various methods of the above embodiments can be completed by instructions, or by instructions controlling relevant hardware, and the instructions can be stored in a non-transitory computer-readable storage medium and loaded and executed by a processor.

Therefore, some embodiments of the present disclosure may provide a non-transitory computer-readable storage medium, which may store a plurality of computer programs. The computer programs can be loaded by a processor to execute the operations in any list update method provided by the embodiments of the present disclosure. For the specific implementation of each operation, reference may be made to the foregoing embodiments, which may not be repeated here.

The storage medium may include: a read only memory (ROM), a random access memory (RAM), a magnetic disk, or an optical disk, etc.

Since the computer programs stored in the storage medium can execute the operations in any list update methods provided by the embodiments of the present disclosure, the beneficial effects that any list update methods provided by the embodiments of the present disclosure can achieve can be achieved. For details, refer to the foregoing embodiments, which may not be repeated here.

Some embodiments of the present disclosure may further provide a computer program product, including computer instructions stored in a computer-readable storage medium. A processor of a computer device may read the computer instructions from the computer-readable storage medium, and the processor may execute the computer instructions, so that the computer device may execute the corresponding processes in any list update methods in the embodiments of the present disclosure, which may be not repeated here for brevity.

Some embodiments of the present disclosure may further provide a computer program, including computer instructions stored in a computer-readable storage medium. A processor of a computer device may read the computer instructions from the computer-readable storage medium, and the processor may execute the computer instructions, so that the computer device may execute the corresponding processes in any list update methods in the embodiments of the present disclosure, which may be not repeated here for brevity.

The above descriptions may be only specific implementations of the present disclosure, but the protection scope of the present disclosure may be not limited thereto. Any person skilled in the art can easily think of changes or substitutions within the technical scope disclosed in the present disclosure, which should be covered in the protection scope of the present disclosure. Therefore, the protection scope of the present disclosure should be subject to the protection scope of the claims.

1. A list update method, comprising:
configuring timeliness tags for lists in a first database according to business scenarios and data volumes, and configuring different message consumption channels for lists with different timeliness tags;
obtaining a change stream of a binary log from a second database, wherein the change stream is configured to associate multiple target lists in the first database;
pushing the change stream of the binary log to a message queue;
routing the change stream of the binary log in the message queue to different message consumption channels for data processing according to the timeliness tags corresponding to the target lists; and
writing processed data into a corresponding target list in the first database.

2. The list update method as claimed in claim 1, wherein configuring the timeliness tags for the lists in the first database according to the business scenarios and the data volumes, and configuring the different message consumption channels for the lists with the different timeliness tags comprise:
configuring the timeliness tags for the lists in the first database according to the business scenarios and the data volumes, and dividing the timeliness tags into a high timeliness tag and a low timeliness tag, wherein the high timeliness tag corresponds to a first message consumption channel, and the low timeliness tag corresponds to a second message consumption channel.

3. The list update method as claimed in claim 2, wherein configuring the timeliness tags for the lists in the first database according to the business scenarios and the data volumes, and dividing the timeliness tags into the high timeliness tag and the low timeliness tag, comprise:
for each list in the first database, in a case where a business scenario of the list is real-time feedback, or a number of documents in the list corresponding to a single change event is less than a preset threshold, marking the list as the high timeliness tag; or
in a case where a business scenario of the list is non-real-time feedback, or a number of documents in the list corresponding to a single change event exceeds a preset threshold, marking the list as the low timeliness tag.

4. The list update method as claimed in claim 2, wherein configuring the different message consumption channels for the lists with the different timeliness tags comprises:
configuring the first message consumption channel for the list with the high timeliness tag; and
configuring the second message consumption channel for the list with the low timeliness tag;
wherein the first message consumption channel and the second message consumption channel reuse a topic and a partition of a same message queue, and the first message consumption channel and the second message consumption channel are isolated through a message consumption channel identifier.

5. The list update method as claimed in claim 2, further comprising:
configuring different concurrency parameters for different message consumption channels, wherein the concurrency parameters comprise at least one of a size of a coroutine pool, a query concurrency of the second database, and a write concurrency of the first database.

6. The list update method as claimed in claim 5, wherein configuring the different concurrency parameters for the different message consumption channels comprises:
the size of the coroutine pool corresponding to the first message consumption channel being larger than the size of the coroutine pool corresponding to the second message consumption channel;
the query concurrency of the second database corresponding to the first message consumption channel being higher than the query concurrency of the second database corresponding to the second message consumption channel; and
the write concurrency of the first database corresponding to the first message consumption channel being higher than the write concurrency of the first database corresponding to the second message consumption channel.

7. The list update method as claimed in claim 6, further comprising:
dynamically adjusting the concurrency parameters of the first message consumption channel and the second message consumption channel according to preset monitoring indicators;
wherein the preset monitoring indicators comprise at least one of a container resource utilization rate, a query response time and an active connection count of the second database, a write throughput of the first database, an update speed of each list in the first database, and a message backlog of the different timeliness tags in the message queue.

8. The list update method as claimed in claim 1, wherein before writing the processed data into the corresponding target list in the first database, the method further comprises:
performing verification and deduplication processing on the processed data; and
according to results of the verification and deduplication processing, performing formatting processing on the processed data that meets requirements to conform to a storage format of the corresponding target list in the first database.

9. A computer device, wherein the computer device comprises a processor and a memory, a computer program is stored in the memory, and the processor is configured to execute a list update method by invoking the computer program stored in the memory, wherein the list update method comprises:
configuring timeliness tags for lists in a first database according to business scenarios and data volumes, and configuring different message consumption channels for lists with different timeliness tags;
obtaining a change stream of a binary log from a second database, wherein the change stream is configured to associate multiple target lists in the first database;
pushing the change stream of the binary log to a message queue;
routing the change stream of the binary log in the message queue to different message consumption channels for data processing according to the timeliness tags corresponding to the target lists; and
writing processed data into a corresponding target list in the first database.

10. The computer device as claimed in claim 9, wherein configuring the timeliness tags for the lists in the first database according to the business scenarios and the data volumes, and configuring the different message consumption channels for the lists with the different timeliness tags comprise:
configuring the timeliness tags for the lists in the first database according to the business scenarios and the data volumes, and dividing the timeliness tags into a high timeliness tag and a low timeliness tag, wherein the high timeliness tag corresponds to a first message consumption channel, and the low timeliness tag corresponds to a second message consumption channel.

11. The computer device as claimed in claim 10, wherein configuring the timeliness tags for the lists in the first database according to the business scenarios and the data volumes, and dividing the timeliness tags into the high timeliness tag and the low timeliness tag comprise:
for each list in the first database, in a case where a business scenario of the list is real-time feedback, or a number of documents in the list corresponding to a single change event is less than a preset threshold, marking the list as the high timeliness tag; or
in a case where a business scenario of the list is non-real-time feedback, or a number of documents in the list corresponding to a single change event exceeds a preset threshold, marking the list as the low timeliness tag.

12. The computer device as claimed in claim 10, wherein configuring the different message consumption channels for the lists with the different timeliness tags comprises:
configuring the first message consumption channel for the list with the high timeliness tag; and
configuring the second message consumption channel for the list with the low timeliness tag;
wherein the first message consumption channel and the second message consumption channel reuse a topic and a partition of a same message queue, and the first message consumption channel and the second message consumption channel are isolated through a message consumption channel identifier.

13. The computer device as claimed in claim 10, further comprising:
configuring different concurrency parameters for different message consumption channels, wherein the concurrency parameters comprise at least one of a size of a coroutine pool, a query concurrency of the second database, and a write concurrency of the first database.

14. The computer device as claimed in claim 13, wherein configuring the different concurrency parameters for the different message consumption channels comprises:
the size of the coroutine pool corresponding to the first message consumption channel being larger than the size of the coroutine pool corresponding to the second message consumption channel;
the query concurrency of the second database corresponding to the first message consumption channel being higher than the query concurrency of the second database corresponding to the second message consumption channel; and
the write concurrency of the first database corresponding to the first message consumption channel being higher than the write concurrency of the first database corresponding to the second message consumption channel.

15. The computer device as claimed in claim 14, wherein the list update method further comprises:
dynamically adjusting the concurrency parameters of the first message consumption channel and the second message consumption channel according to preset monitoring indicators;
wherein the preset monitoring indicators comprise at least one of a container resource utilization rate, a query response time and an active connection count of the second database, a write throughput of the first database, an update speed of each list in the first database, and a message backlog of the different timeliness tags in the message queue.

16. A non-transitory computer-readable storage medium, wherein the computer-readable storage medium stores a computer program, and the computer program is adapted to be loaded by a processor to execute a list update method, wherein the list update method comprises:
configuring timeliness tags for lists in a first database according to business scenarios and data volumes, and configuring different message consumption channels for lists with different timeliness tags;
obtaining a change stream of a binary log from a second database, wherein the change stream is configured to associate multiple target lists in the first database;
pushing the change stream of the binary log to a message queue;
routing the change stream of the binary log in the message queue to different message consumption channels for data processing according to the timeliness tags corresponding to the target lists; and
writing processed data into a corresponding target list in the first database.

17. The non-transitory computer-readable storage medium as claimed in claim 16, wherein configuring the timeliness tags for the lists in the first database according to the business scenarios and the data volumes, and configuring the different message consumption channels for the lists with the different timeliness tags comprise:
configuring the timeliness tags for the lists in the first database according to the business scenarios and the data volumes, and dividing the timeliness tags into a high timeliness tag and a low timeliness tag, wherein the high timeliness tag corresponds to a first message consumption channel, and the low timeliness tag corresponds to a second message consumption channel.

18. The non-transitory computer-readable storage medium as claimed in claim 17, wherein configuring the timeliness tags for the lists in the first database according to the business scenarios and the data volumes, and dividing the timeliness tags into the high timeliness tag and the low timeliness tag, comprise:
for each list in the first database, in a case where a business scenario of the list is real-time feedback, or a number of documents in the list corresponding to a single change event is less than a preset threshold, marking the list as the high timeliness tag; or
in a case where a business scenario of the list is non-real-time feedback, or a number of documents in the list corresponding to a single change event exceeds a preset threshold, marking the list as the low timeliness tag.

19. The non-transitory computer-readable storage medium as claimed in claim 17, wherein configuring the different message consumption channels for the lists with the different timeliness tags comprises:
configuring the first message consumption channel for the list with the high timeliness tag; and
configuring the second message consumption channel for the list with the low timeliness tag;
wherein the first message consumption channel and the second message consumption channel reuse a topic and a partition of a same message queue, and the first message consumption channel and the second message consumption channel are isolated through a message consumption channel identifier.

20. The non-transitory computer-readable storage medium as claimed in claim 16, wherein before writing the processed data into the corresponding target list in the first database, the method further comprises:
performing verification and deduplication processing on the processed data; and
according to results of the verification and deduplication processing, performing formatting processing on the processed data that meets requirements to conform to a storage format of the corresponding target list in the first database.
